(19) United States
(12) Patent Application Publication
(10) Pub. No.: US 2022/0198178 A1
(43) Pub. Date: Jun. 23, 2022

(54) METHOD AND APPARATUS FOR IDENTIFYING THE FLOOR OF A BUILDING

(71) Applicant: HERE Global B.V., Eindhoven (NL)

(72) Inventors: Henri Jaakko Julius NURMINEN, Tampere (FI); Pavel Ivanov, Tampere (FI); Lauri Aarne Johannes Wirola, Tampere (FI)

(73) Assignee: HERE Global B.V., Eindhoven (NL)

(21) Appl. No.: 17/131,011

(22) Filed: Dec. 22, 2020

(51) Int. Cl. G06K 9/00; G01C 21/20; G01S 5/02

(52) U.S. Cl. CPC G06K 9/0063; G06K 9/00684; G01S 5/02525; G01C 21/206; G06K 9/00671

(57) ABSTRACT

A method, apparatus and computer program product are provided to identify the floor of a building. In the context of a method, an image captured by a mobile device is received. The image includes a representation of a floor plan of the floor of the building. The method also includes comparing, with processing circuitry, the representation of the floor plan from the image to one or more predefined indoor maps of respective floors. Based upon the comparing, the method further includes identifying, with the processing circuitry, the floor depicted by the floor plan from the image captured by the mobile device.

A method, apparatus and computer program product are provided in accordance with an example embodiment in order to identify a location within a building and, more particularly, to identify the floor of the building.

### BACKGROUND

Traditional positioning technologies utilizing either satellite-based radio navigation signals or cellular signals provide reliable positioning performance in many outdoor areas. For example, in those outdoor areas having a relatively clear line of sight to the satellites or having reasonably good reception of the cellular signals, the location of a mobile device, such as a mobile telephone, can generally be determined with sufficient accuracy. However, these same positioning technologies do not typically provide satisfactory performance indoors with the location of a mobile device being determined with reduced accuracy and increased uncertainty. In this regard, satellite-based radio navigation systems generally do not sufficiently penetrate through the walls and roofs of various structures to allow for adequate signaling reception indoors, and cellular signals typically have a bandwidth that is too narrow to allow for accurate ranging indoors. As such, satellite and cellular-based positioning technologies typically do not provide the desired positioning accuracy, such as two to three meters, and do not provide sufficient coverage, such as coverage approaching 100%, indoors. Additionally, satellite and cellular-based positioning technology generally do not reliably detect the floor on which a mobile device is located within a multi-story building as desired in indoor positioning applications. As a result, positioning technologies utilizing either satellite-based radio navigation signals or cellular signals cannot generally determine the position of a mobile device, such as for navigational or other purposes, both outdoors and indoors in a seamless and reliable manner.

Various indoor positioning technologies have therefore been developed and deployed. Some of these indoor positioning technologies are based on short range beacons termed pseudolites. Others utilize ultrasound positioning or Wi-Fi fingerprinting techniques, or positioning techniques reliant upon Zigbee or LoRa networks. Still others employ positioning beacons that emit Bluetooth (BT) or Bluetooth Low Energy (BTLE) signals from which a location may be determined based upon the angles of arrival of the signals at a mobile device. However, these indoor positioning techniques generally require either the deployment of additional infrastructure, such as beacons, tags, etc., or an exhaustive radio survey of the indoor locations for which location services are to be provided.

A radio-based indoor positioning technology has been developed that models the existing radio environment, such as the cellular, Wi-Fi, Bluetooth and/or ultra-wideband radio environment, from observed radio measurements. In conjunction with cellular positioning technology, the radio measurements may include global and/or local identifiers of the cellular network cells that are observed as well as signal strength and/or pathloss estimates and/or timing measurements, such as the Timing Advance or Round-Trip Time. In relation to Wi-Fi or other wide-area local access networks (WLANs), the radio measurements may include an identifier of the access point, such as a basic service set identifier (BSSID) of the access point or a media access control (MAC) address of the air interface as well as service set identifiers (SSIDs), signal strength measurements, e.g., received signal strength index, physical Rx level and/or pathloss estimates, and/or timing measurements, e.g., Round-Trip Time. The dynamics of the indoor radio propagation environment may be captured by a radio map in a compressible and accurate manner. Examples of radio maps include those based upon coverage areas, node positions, radio propagation models, Rx fields, etc. A different radio map may be created for each floor of a multi-story building such that a radio-based indoor positioning technique also provides for reliable floor detection.

By relying upon the existing radio environment, this radio-based indoor positioning technique does not require the deployment of additional infrastructure, such as beacons, tags, etc. However, measurements of the radio environment within the buildings in which the positioning technique is to be deployed is necessary in order to create and update the radio maps. The measurements may be in the form of probe data, that is, fingerprints, that includes information regarding the radio signals along with the location of the mobile device at the time at which the radio signals were measured and the time at which the radio signals were measured. Large volumes of probe data may be collected by crowdsourcing or with volunteers surveying the indoor areas.

However, the identification of the location of the mobile device when a radio signal measurement is obtained may be more challenging in an indoor environment due to, for example, the limitations associated with positioning technologies utilizing either satellite-based radio navigation signals or cellular signals which may result in increased uncertainty or decreased accuracy in the locations that are determined. These challenges associated with the identification of the location of the mobile device in an indoor environment are increased in conjunction with the identification of the location of the mobile device within a multi-story building. In these settings, the location of the mobile device is defined not only by the two-dimensional location of the mobile device on a floor of the building, but also by the identification of the floor of the building upon which the mobile device is located.

While satellite-based radio navigation signals may provide information regarding the altitude of a mobile device, reliance upon satellite-based radio navigation signals in an indoor environment may not be possible or lack sufficient accuracy or otherwise be too unreliable for indoor positioning applications. Also, some mobile devices include a barometric sensor for providing information regarding altitude of the mobile device. However, it may prove difficult to accurately correlate the altitude of a mobile device to the floor of a multi-story building on which the mobile device is located. In this regard, correlations between he altitude of a mobile device and the floor of a multi-story building on which the mobile device is location are dependent upon assumptions relating to the height of each floor of a building and assumptions relating to the floor numbering convention of the building. In relation to the assumptions relating to the floor numbering convention of the building, different buildings may differently number the floors with some buildings numbering the floors sequentially beginning with 1 and other buildings utilizing a different numbering convention. For example, some buildings, such as buildings built on a sloped lot or buildings having an attached parking structure, may have ground level entrances to different floors on different sides of the building. With respect to these buildings, different numbering conventions may be utilized for the floors, e.g., a numbering convention of ground-1^{st}-2^{nd}-etc. as compared with a numbering convention of 1^{st}-2^{nd}-3^{rd}-etc. Thus, reliance solely upon altitude information may potentially result in inaccurate identification of the floor of the multi-story building upon which the mobile device is located.

With respect to the altitude information provided by a barometric sensor, additional uncertainties may be introduced by the pressure within the building that is maintained by the heating, ventilation and air conditioning (HVAC) system of the building. For example, the HVAC system may maintain a common pressure on all floors of a multi-story building such that pressure sensed by the barometric sensor of a mobile device does not correctly correlate to the altitude of the mobile device and, as such, does not correctly correlate to the floor on which the mobile device is located. Even in instances in which the HVAC system does not maintain a common pressure within a building, the HVAC system may alter the pressure within the building in comparison to the outdoor environment such that the altitude sensed by a barometric sensor is dependent upon assumptions as to the impact of the HVAC system, thereby decreasing the confidence in the resulting determination of the floor upon which a mobile device is located.

As such, a user who is collecting probe data may manually provide the location, including the floor, during the probe data collection process. While the location data that is manually provided may sometimes be sufficiently accurate, the manual entry of location data is laborious, not scalable and prone to errors, thereby generally limiting this approach to the collection of probe data by trusted users, as opposed to a broader implementation via crowdsourcing.

Even in instances in which the horizontal location of a mobile device, such as the latitude and longitude of the mobile device, is provided with sufficient accuracy, improper identification of the floor of the building on which the mobile device is located creates difficulties. Since the different floors of a multi-story building may have different floor plans, the improper identification of the floor of the building on which the mobile device is located may cause inaccurate directions to be provided by a navigation application to the mobile device or may decrease the accuracy of a radio map that is being created utilizing the probe data collected by the mobile device. Additionally, the improper identification of the floor of the building on which the mobile device is located may decrease the overall confidence in the location of the mobile device including the confidence in the horizontal location of the mobile device which may actually have been provided with sufficient accuracy.

### BRIEF SUMMARY

A method, apparatus and computer program product are therefore provided in accordance with an example embodiment in order to identify the location of a mobile device, including the floor of a multi-story building on which the mobile device is located, with increased accuracy and reliability. As a result, a navigation application may reference the correct floor plan of the floor on which the mobile device is located and provide more accurate directions to the mobile device. Additionally, in relation to the collection of probe data to facilitate the construction or updating of a radio map, the accurate identification of the location of a mobile device, including the floor of the building on which the mobile device is located, may increase the accuracy of the resulting radio map. Further, the increased accuracy and reliability with which the floor of the building on which the mobile device is located is identified increase the overall confidence in the location of the mobile device including the confidence in the horizontal location of the mobile device.

In an example embodiment, a method is provided for identifying a floor of a building. The method includes receiving an image captured by a mobile device. The image includes a representation of a floor plan of the floor of the building. The method also includes comparing, with processing circuitry, the representation of the floor plan from the image to one or more predefined indoor maps of respective floors. For example, the method may compare the representation of the floor plan from the image to one or more predefined indoor maps by comparing the representation of the floor plan from the image to a plurality of indoor maps of different resolutions of each of one or more floors of the building. Based upon the comparing, the method further includes identifying, with the processing circuitry, the floor depicted by the floor plan from the image captured by the mobile device.

The method of an example embodiment also includes causing positioning information to be provided to the mobile device that identifies the floor of the building on which the mobile device is located. Additionally or alternatively, the method of an example embodiment also includes associating the floor that was identified with fingerprint data representative of radio signals captured by the mobile device while located on the floor. In an example embodiment, the method further includes determining whether the floor on which the image was captured by the mobile device has already been determined or has not yet been determined. In an instance in which the floor on which the image was captured has already been determined, the method identifies the floor on which the image was captured by the mobile device based upon a prior determination of the floor. Additionally, the method of this example embodiment compares the representation of the floor plan to one or more predefined indoor maps of respective floors in a manner that is dependent upon determining that the floor on which the image was captured has not yet been determined.

The method of an example embodiment also includes determining that the floor on which the mobile device is located has changed and, in response to the floor on which the mobile device is located changing, triggering the image to be captured by the mobile device or causing a user of the mobile device to be prompted to capture the image. In an example embodiment, the method further includes determining that the mobile device is capturing the image such that comparing the representation of the floor plan to one or more predefined indoor maps of respective floors is dependent upon determining that the mobile device is capturing the image. The method of an example embodiment also includes determining an approximate location of the mobile device. In this example embodiment, the method compares the representation of the floor plan from the image to one or more predefined indoor maps by selecting the one or more predefined indoor maps for comparison to the representation of the floor plan from the image based upon the approximate location of the mobile device.

In another example embodiment, an apparatus is provided that is configured to identify a floor of a building. The apparatus includes processing circuitry and at least one memory including computer program code instructions with the computer program code instructions configured to, when executed by the processing circuity, cause the apparatus to receive an image captured by a mobile device. The image includes a representation of a floor plan of the floor of the building. The computer program code instructions are also configured to, when executed by the processing circuity, cause the apparatus to compare the representation of the floor plan from the image to one or more predefined indoor maps of respective floors. Based upon the comparison, the computer program code instructions are further configured to, when executed by the processing circuity, cause the apparatus to identify the floor depicted by the floor plan from the image captured by the mobile device.

The computer program code instructions are further configured to, when executed by the processing circuity, cause the apparatus of an example embodiment to cause positioning information to be provided to the mobile device that identifies the floor of the building on which the mobile device is located. Additionally or alternatively, the computer program code instructions are further configured to, when executed by the processing circuity, cause the apparatus of an example embodiment to associate the floor that was identified with fingerprint data representative of radio signals captured by the mobile device while located on the floor. In an example embodiment, the computer program code instructions are further configured to, when executed by the processing circuity, cause the apparatus to determine whether the floor on which the image was captured by the mobile device has already been determined or has not yet been determined. In an instance in which the floor on which the image was captured has already been determined, the computer program code instructions are configured to, when executed by the processing circuity, cause the apparatus to identify the floor on which the image was captured by the mobile device based upon a prior determination of the floor. In addition, the computer program code instructions are configured to, when executed by the processing circuity, cause the apparatus of this example embodiment to compare the representation of the floor plan to one or more predefined indoor maps of respective floors in an instance in which the floor on which the image was captured has not yet been determined.

The computer program code instructions are further configured to, when executed by the processing circuity, cause the apparatus of an example embodiment to determine that the floor on which the mobile device is located has changed and, in response to the floor on which the mobile device is located changing, trigger the image to be captured by the mobile device or cause a user of the mobile device to be prompted to capture the image. In an example embodiment, the computer program code instructions are further configured to, when executed by the processing circuity, cause the apparatus to determine that the mobile device is capturing the image. In this example embodiment, the computer program code instructions are configured to, when executed by the processing circuity, cause the apparatus to compare the representation of the floor plan to one or more predefined indoor maps of respective floors in a manner that is dependent upon determining that the mobile device is capturing the image.

The computer program code instructions are further configured to, when executed by the processing circuity, cause the apparatus of an example embodiment to determine an approximate location of the mobile device. In this example embodiment, the computer program code instructions are configured to, when executed by the processing circuity, cause the apparatus to compare the representation of the floor plan from the image to one or more predefined indoor maps by selecting the one or more predefined indoor maps for comparison to the representation of the floor plan from the image based upon the approximate location of the mobile device. The computer program code instructions are further configured to, when executed by the processing circuity, cause the apparatus of an example embodiment to compare the representation of the floor plan from the image to one or more predefined indoor maps by comparing the representation of the floor plan from the image to a plurality of indoor maps of different resolutions of each of one or more floors of the building.

In a further example embodiment, a computer program product is provided that is configured to identify a floor of a building. The computer program product includes at least one non-transitory computer-readable storage medium having computer-executable program code instructions stored therein with the computer-executable program code instructions including program code instructions configured to, when executed by an apparatus, cause the apparatus, to receive an image captured by a mobile device. The image includes a representation of a floor plan of the floor of the building. The computer-executable program code instructions also include program code instructions configured to, when executed by the apparatus, cause the apparatus, to compare the representation of the floor plan from the image to one or more predefined indoor maps of respective floors. For example, the program code instructions configured to compare the representation of the floor plan from the image to one or more predefined indoor maps may include program code instructions configured to compare the representation of the floor plan from the image to a plurality of indoor maps of different resolutions of each of one or more floors of the building. Based upon the comparing, the computer-executable program code instructions further include program code instructions configured to, when executed by the apparatus, cause the apparatus, to identify the floor depicted by the floor plan from the image captured by the mobile device.

The computer-executable program code instructions also include program code instructions configured to, when executed by the apparatus, cause the apparatus of an example embodiment to cause positioning information to be provided to the mobile device that identifies the floor of the building on which the mobile device is located. Additionally or alternatively, the computer-executable program code instructions include program code instructions configured to, when executed by the apparatus, cause the apparatus of an example embodiment to associate the floor that was identified with fingerprint data representative of radio signals captured by the mobile device while located on the floor. In an example embodiment, the computer-executable program code instructions further include program code instructions configured to, when executed by the apparatus, cause the apparatus to determine whether the floor on which the image was captured by the mobile device has already been determined or has not yet been determined. In an instance in which the floor on which the image was captured has already been determined, the computer-executable program code instructions includes program code instructions configured to, when executed by the apparatus, cause the apparatus to identify the floor on which the image was captured by the mobile device based upon a prior determination of the floor. Additionally, the computer-executable program code instructions include program code instructions configured to, when executed by the apparatus, cause the apparatus of this example embodiment to compare the representation of the floor plan to one or more predefined indoor maps of respective floors in a manner that is dependent upon determining that the floor on which the image was captured has not yet been determined.

The computer-executable program code instructions also include program code instructions configured to, when executed by the apparatus, cause the apparatus of an example embodiment to determine that the floor on which the mobile device is located has changed and, in response to the floor on which the mobile device is located changing, to trigger the image to be captured by the mobile device or to cause a user of the mobile device to be prompted to capture the image. In an example embodiment, the computer-executable program code instructions also include program code instructions configured to, when executed by the apparatus, cause the apparatus to determine that the mobile device is capturing the image such that comparing the representation of the floor plan to one or more predefined indoor maps of respective floors is dependent upon determining that the mobile device is capturing the image. The computer-executable program code instructions also include program code instructions configured to, when executed by the apparatus, cause the apparatus of an example embodiment to determine an approximate location of the mobile device. In this example embodiment, the computer-executable program code instructions also include program code instructions configured to, when executed by the apparatus, cause the apparatus to compare the representation of the floor plan from the image to one or more predefined indoor maps by selecting the one or more predefined indoor maps for comparison to the representation of the floor plan from the image based upon the approximate location of the mobile device.

In yet another example embodiment, an apparatus is provided for identifying a floor of a building. The apparatus includes means for receiving an image captured by a mobile device. The image includes a representation of a floor plan of the floor of the building. The apparatus also includes means for comparing the representation of the floor plan from the image to one or more predefined indoor maps of respective floors. For example, the means for comparing the representation of the floor plan from the image to one or more predefined indoor maps may include means for comparing the representation of the floor plan from the image to a plurality of indoor maps of different resolutions of each of one or more floors of the building. Based upon the comparing, the apparatus further includes means for identifying the floor depicted by the floor plan from the image captured by the mobile device.

The apparatus of an example embodiment also includes means for causing positioning information to be provided to the mobile device that identifies the floor of the building on which the mobile device is located. Additionally or alternatively, the apparatus of an example embodiment also includes means for associating the floor that was identified with fingerprint data representative of radio signals captured by the mobile device while located on the floor. In an example embodiment, the apparatus further includes means for determining whether the floor on which the image was captured by the mobile device has already been determined or has not yet been determined. In an instance in which the floor on which the image was captured has already been determined, the apparatus includes means for identifying the floor on which the image was captured by the mobile device based upon a prior determination of the floor. Additionally, the apparatus of this example embodiment includes means for comparing the representation of the floor plan to one or more predefined indoor maps of respective floors in a manner that is dependent upon determining that the floor on which the image was captured has not yet been determined.

The apparatus of an example embodiment also includes means for determining that the floor on which the mobile device is located has changed and, in response to the floor on which the mobile device is located changing, means for triggering the image to be captured by the mobile device or means for causing a user of the mobile device to be prompted to capture the image. In an example embodiment, the apparatus further includes means for determining that the mobile device is capturing the image such that comparing the representation of the floor plan to one or more predefined indoor maps of respective floors is dependent upon determining that the mobile device is capturing the image. The apparatus of an example embodiment also includes means for determining an approximate location of the mobile device. In this example embodiment, the means for comparing the representation of the floor plan from the image to one or more predefined indoor maps includes means for selecting the one or more predefined indoor maps for comparison to the representation of the floor plan from the image based upon the approximate location of the mobile device.

In an example embodiment, a method is provided that includes receiving an image captured by a mobile device. The image includes a representation of a floor plan of a floor of a building. The method also includes associating, with processing circuitry, the representation of the floor plan with an indication of the floor depicted by the floor plan from the image captured by the mobile device. The method further includes causing the representation of the floor plan and the indication of the floor to be contributed for purposes of creating or updating a map.

The method of an example embodiment also includes receiving the indication of the floor depicted by the floor plan from the image captured by the mobile device based upon the image captured by the mobile device that includes the indication of the floor. In an example embodiment, the method further includes receiving the indication of the floor depicted by the floor plan from the image captured by the mobile device based upon input by a user of the mobile device of the floor on which the mobile device is located. The method of an example embodiment may also include creating or updating the map of the floor based upon the representation of the floor plan.

In another example embodiment, an apparatus is provided that includes processing circuitry and at least one memory including computer program code instructions with the computer program code instructions configured to, when executed by the processing circuity, cause the apparatus to receive an image captured by a mobile device. The image includes a representation of a floor plan of a floor of a building. The computer program code instructions are also configured to, when executed by the processing circuity, cause the apparatus to associate the representation of the floor plan with an indication of the floor depicted by the floor plan from the image captured by the mobile device. The computer program code instructions are further configured to, when executed by the processing circuity, cause the apparatus to cause the representation of the floor plan and the indication of the floor to be contributed for purposes of creating or updating a map.

The computer program code instructions are also configured to, when executed by the processing circuity, cause the apparatus of an example embodiment to receive the indication of the floor depicted by the floor plan from the image captured by the mobile device based upon an image captured by the mobile device that includes the indication of the floor. In an example embodiment, the computer program code instructions are further configured to, when executed by the processing circuity, cause the apparatus to receive the indication of the floor depicted by the floor plan from the image captured by the mobile device based upon input by a user of the mobile device of the floor on which the mobile device is located. The computer program code instructions of an example embodiment are further configured to create or update the map of the floor based upon the representation of the floor plan.

In a further example embodiment, a computer program product is provided that includes at least one non-transitory computer-readable storage medium having computer-executable program code instructions stored therein with the computer-executable program code instructions including program code instructions configured to, when executed by an apparatus, cause the apparatus, to receive an image captured by a mobile device. The image includes a representation of a floor plan of a floor of a building. The computer-executable program code instructions also include program code instructions configured to, when executed by the apparatus, cause the apparatus to associate the representation of the floor plan with an indication of the floor depicted by the floor plan from the image captured by the mobile device. The computer-executable program code instructions further include program code instructions configured to, when executed by the apparatus, cause the apparatus to cause the representation of the floor plan and the indication of the floor to be contributed for purposes of creating or updating a map.

The computer-executable program code instructions also include program code instructions configured to, when executed by the apparatus, cause the apparatus of an example embodiment, to receive the indication of the floor depicted by the floor plan from the image captured by the mobile device based upon an image captured by the mobile device that includes the indication of the floor. In an example embodiment, the computer-executable program code instructions further include program code instructions configured to, when executed by the apparatus, cause the apparatus, to receive the indication of the floor depicted by the floor plan from the image captured by the mobile device based upon input by a user of the mobile device of the floor on which the mobile device is located. The computer-executable program code instructions of an example embodiment also include program code instructions configured to, when executed by the apparatus, to create or update the map of the floor based upon the representation of the floor plan.

In yet another example embodiment, an apparatus is provided that includes means for receiving an image captured by a mobile device. The image includes a representation of a floor plan of a floor of a building. The apparatus also includes means for associating the representation of the floor plan with an indication of the floor depicted by the floor plan from the image captured by the mobile device. The apparatus further includes means for causing the representation of the floor plan and the indication of the floor to be contributed for purposes of creating or updating a map.

The apparatus of an example embodiment also includes means for receiving the indication of the floor depicted by the floor plan from the image captured by the mobile device based upon an image captured by the mobile device that includes the indication of the floor. In an example embodiment, the apparatus further includes means for receiving the indication of the floor depicted by the floor plan from the image captured by the mobile device based upon input by a user of the mobile device of the floor on which the mobile device is located. The apparatus of an example embodiment also includes means for creating or updating the map of the floor based upon the representation of the floor plan.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 is a perspective view of a portion of a building having a representation of a floor plan of a respective floor of the building mounted upon a wall of the building;

FIG. 2 is a block diagram of an apparatus that may be specifically configured in accordance with an example embodiment of the present disclosure;

FIG. 3 is a flowchart illustrating operations performed, such as by the apparatus of FIG. 2, in accordance with an example embodiment of the present disclosure;

FIG. 4 is a flowchart illustrating operations performed, such as by the apparatus of FIG. 2, in relation to the identification of the floor on which an image including a representation of a floor plan was captured in accordance with an example embodiment of the present disclosure; and

FIG. 5 is a flowchart illustrating operations performed, such as by the apparatus of FIG. 2, in relation to causing a representation of a floor plan and an indication of the corresponding floor to be contributed for purposes of creating or updating a map in accordance with another example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment in order to determine the location of a mobile device with increased accuracy. In this regard, the method, apparatus and computer program product are configured to determine the location of a mobile device within a building with increased accuracy and, more particularly, to determine the floor of a multi-story building on which a mobile device is located with increased accuracy. As a result, positioning information may be provided to the mobile device, such as by a navigation or mapping application, that more accurately identifies the floor of the building on which the mobile device is located and, some embodiments, that provides more accurate navigational or mapping information to the mobile device based upon the floor plan of the floor that has been identified. Additionally or alternatively, a more accurate determination of the floor on which the mobile device is located may permit fingerprint data collected by the mobile device to be more consistently associated with the floor on which the mobile device was located during the collection of the fingerprint data such that a radio map created or updated based upon the fingerprint data is also more accurate.

In relation to the identification of the floor on which a mobile device is located, an image may be captured by the mobile device that includes a representation of a floor plan of a floor of the building, such as the floor on which the mobile device is located or the floor to which the user of the mobile device will proceed. By utilizing the representation of the floor plan of the floor of the building on which the mobile device is or will be located as described below, the floor on which the mobile device is located or the floor to which the user of the mobile device will proceed may be determined, such as in a more accurate and reliable manner.

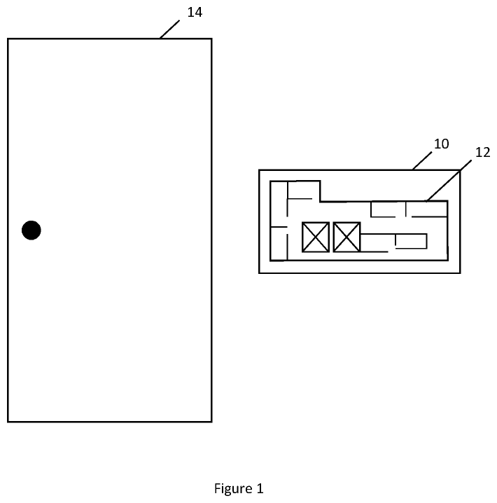

A representation of the floor plan of a floor of a multi-story building in which the mobile device is or will be located may be provided in various manners. By way of example, FIG. 1 depicts a drawing or other rendering 10 of the floor plan 12 of a floor of a multi-story building in which the mobile device is or will be located. The drawing or other rendering of the floor plan may be mounted to a wall on the floor of the building that corresponds to the floor plan depicted by the drawing or other rendering. The representation of the floor plan may be mounted to the wall on the floor of the building at any of various locations including in an elevator lobby, near an emergency exit 14, in a reception or greeting area, along a busy corridor, etc. The drawing or other rendering of the floor plan may be provided for any of a variety of purposes including, for example, the identification of an exit route to be taken during an emergency situation, such as during an evacuation of the floor of the building. Although the drawing or other representation of the floor plan of a respective floor may be mounted on a wall on the floor itself, the representation of the floor plan may be presented in other locations, such as within a lobby of the building, on signage associated with a building, etc.

The apparatus 20 configured to identify the floor of a building may be embodied by any of a variety of computing devices. In an example embodiment, the apparatus is embodied by a network-based computing device, such as a server, a computer workstation, a distributed network of computing devices, a personal computer or any other type of network-based computing device. In this example embodiment, the apparatus is in communication with one or more mobile devices that capture images including a representation of a floor plan of a floor of a multi-story building on which a respective mobile device is or will be located. Alternatively, the apparatus may be embodied by the mobile device, such as a mobile terminal including, for example, a personal digital assistant (PDA), mobile telephone, smart phone, personal navigation device, smart watch, tablet computer, an augmented reality (AR) device, a gaming device, or any combination of the aforementioned and other types of portable computer devices. In other example embodiments, the apparatus may be collectively embodied by two or more computing devices configured to cooperate in order to perform the functions described herein. In this example embodiment, the apparatus may be embodied by a combination of a network-based computing device and one or more mobile devices.

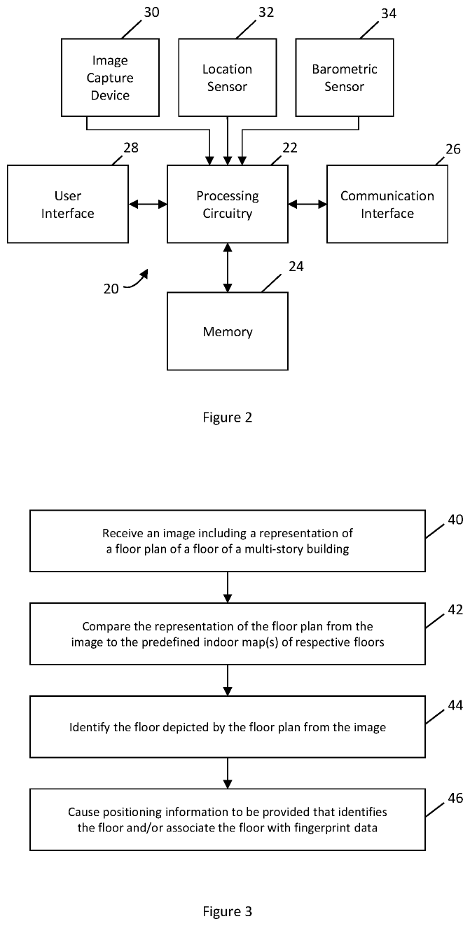

Regardless of the type of computing device that embodies the apparatus 20, the apparatus of an example embodiment depicted in FIG. 2 includes, is associated with or is in communication with processing circuitry 22, a memory 24 and a communication interface 26. In some embodiments, the apparatus also optionally includes, is associated with or is in communication with a user interface 28, such as in an embodiment in which the apparatus is embodied by a mobile device. In an embodiment in which the apparatus is embodied by a mobile device, the apparatus may also optionally include, be associated with or be in communication with an image capture device 30, such as a camera, and one or more sensors including, for example, a location sensor 32, such as a Global Navigation Satellite System (GNSS) receiver, and a barometric sensor 34.

In some embodiments, the processing circuitry 22 (and/or co-processors or any other processors assisting or otherwise associated with the processing circuitry) can be in communication with the memory 24 via a bus for passing information among components of the apparatus 20. The memory can be non-transitory and can include, for example, one or more volatile and/or non-volatile memories. In other words, for example, the memory may be an electronic storage device (for example, a computer readable storage medium) comprising gates configured to store data (for example, bits) that can be retrievable by a machine (for example, a computing device like the processing circuitry). The memory can be configured to store information, data, content, applications, instructions, or the like for enabling the apparatus to carry out various functions in accordance with an example embodiment of the present disclosure. For example, the memory can be configured to buffer input data for processing by the processing circuitry. Additionally or alternatively, the memory can be configured to store instructions for execution by the processing circuitry.

The processing circuitry 22 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally or alternatively, the processing circuitry can include one or more processors configured in tandem via the bus to enable independent execution of instructions, pipelining and/or multithreading.

In an example embodiment, the processing circuitry 22 can be configured to execute instructions stored in the memory 24 or otherwise accessible to the processing circuitry. Alternatively or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 20 of an example embodiment can also include the communication interface 26. The communication interface can be any means such as a device or circuitry embodied in either hardware or a combination of hardware and software that is configured to receive and/or transmit data from/to other electronic devices in communication with the apparatus, such as by providing for communication between a network-based computing device and a user device. The communication interface can be configured to communicate in accordance with various wireless protocols including Global System for Mobile Communications (GSM), such as but not limited to Long Term Evolution (LTE). In this regard, the communication interface can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally or alternatively, the communication interface can include the circuitry for interacting with the antenna(s) to cause transmission of signals via the antenna(s) or to handle receipt of signals received via the antenna(s). In some environments, the communication interface can alternatively or also support wired communication.

The apparatus 20 may also optionally include a user interface 28 that may, in turn, be in communication with the processing circuitry 22 to provide output to the user and, in some embodiments, to receive an indication of a user input. For example, the apparatus may include a user interface in those example embodiments in which the apparatus is embodied by a mobile device that is utilized to an image including a representation of the floor plan. The user interface may include a display and, in some embodiments, may also include a keyboard, a mouse, a joystick, a touch screen, touch areas, soft keys, one or more microphones, a plurality of speakers, or other input/output mechanisms. In one embodiment, the processing circuitry may comprise user interface circuitry configured to control at least some functions of one or more user interface elements such as a display and, in some embodiments, a plurality of speakers, a ringer, one or more microphones and/or the like. The processing circuitry and/or user interface circuitry embodied by the processing circuitry may be configured to control one or more functions of one or more user interface elements through computer program instructions (for example, software and/or firmware) stored on a memory accessible to the processing circuitry (for example, memory 24, and/or the like).

In an embodiment in which the apparatus 20 is embodied by a mobile device, the apparatus may also include, be associated with or be in communication with a location sensor 32. The location sensor may be embodied in various manners but, in one embodiment, is a location sensor utilized in conjunction with outdoor positioning technologies. As such, the location sensor of an example embodiment is a GNSS sensor, such as a Global Positioning System (GPS) sensor, configured to communicate with the GNSS and to determine the location of the user device based thereupon. As shown in FIG. 2, in an instance in which the apparatus is embodied by a mobile device, the apparatus may also include, be associated with or otherwise be in communication with a barometric sensor 34 configured to measure the barometric pressure to which the mobile device is exposed. Additionally, the apparatus may include, be associated with or be in communication with any of a variety of other sensors, such as those that rely upon the receipt of radio signals.

Referring now to FIG. 3, the operations performed, such as by the apparatus 20 of FIG. 2, in accordance with an example embodiment are depicted. As shown in block 40, the apparatus of an example embodiment includes means, such as the processing circuitry 22, the communication interface 26 or the like, for receiving an image captured by a mobile device. The image includes the representation of the floor plan of a floor of a multi-story building on which the mobile device is presently located or to which the user of the mobile device plans to proceed. Regardless of whether the representation in the floor plan of the floor of the multi-story building is captured by the mobile device on the same floor or in another location, the representation of the floor plan is of a floor of a multi-story building on which the mobile device is or will be located. Any of a variety of different types of images may be received including a still image, a video, etc. The images may be captured for any of various purposes. For example, images may be intentionally captured of the representation of the floor plan to permit the floor on which the mobile device to be identified with increased confidence. Alternatively, images that include the representation of the floor plan may be captured for other purposes, such as during the capture of a video. In an embodiment in which the mobile device is an AR device, images of a user's surroundings including a representation of the floor plan may be captured, either automatically or under manual control, and additional AR content may be overlaid thereon during the context of the AR experience.

In an embodiment in which the mobile device embodies the apparatus 20 configured to identify the floor of the building, the processing circuitry 22 may be configured to receive the image including the representation of the floor plan of the floor of the building from an image capture device 30, such as a camera, that is embodied by the mobile device or that it associated or otherwise in communication with the mobile device. Alternatively, in an embodiment in which the apparatus is embodied by computing device separate from the mobile device, such as a network-based computing device, the apparatus may be configured to receive the image including the representation of the floor plan on the floor of the building from the mobile device. The apparatus, such as the processing circuitry, the communication interface 26 or the like, of this example embodiment may be configured to receive the image in real time or near real time relative to the capture of the image, such as in an instance in which the analysis of the image is utilized in conjunction with the provision of positioning information, such as provided by a navigation or mapping application. Alternatively, the apparatus, such as the processing circuitry, the communication interface or the like, of this example embodiment may receive the image including the representation of the floor plan of the floor of the building from the mobile device at some subsequent point in time following the capture of the image, such as in conjunction with a batch process. The receipt of the image captured by the mobile device in accordance to the batch process may be utilized, for example, in conjunction with the analysis of fingerprint data collected by the mobile device for purposes of creating or updating a radio map.

As shown in block 42 of FIG. 3, the apparatus 20 also includes means, such as the processing circuitry or the like, for comparing the representation of the floor plan from the image to one or more predefined indoor maps of respective floors of the building. The predefined indoor map(s) may have any of various formats, such as geoJSON in one example embodiment. The building in which the mobile device is or will be located and for which the floor plans will be analyzed may be identified in various manners. For example, the location sensor 32 of the mobile device may provide information regarding the horizontal location, e.g., latitude and longitude, of the mobile device and the building located at that location may be identified, such as based upon reference to a map or map data stored by the memory 24 or by a database with which the computing device that embodies the apparatus is in communication. Alternatively, the building may be identified based upon input provided by a user of the mobile device, such as via the user interface 38, or an indication of the building, such as the name and/or address of the building may be included in the image of the representation of the floor plan that is captured by the mobile device.

The predefined indoor maps of a plurality of floors of the building, such as predefined indoor maps of all of the floors, may be stored, such as by memory 24 or by a database with which the computing device that embodies the apparatus 20 is in communication. The representation of the floor plan from the image may be compared to one or more predefined indoor maps of respective floors of the building in various manners. In one example embodiment, the one or more predefined indoor maps of respective floors of the buildings have been converted, such as by the processing circuitry 22, to an image format and the representation of the floor plan from the image may be compared to the one or more predefined indoor maps of the respective floors of the building in the image format, such as by performing a pixel-by-pixel comparison. The conversion of the predefined indoor maps of the respective floors of the building to the image format may be performed in advance of the capture of the image including the representation of the floor plan of a floor of the building with the resulting predefined indoor maps of respective floors of the building in the image format being stored by memory or a database with which the computing device that embodies apparatus is in communication. Alternatively, the predefined indoor maps of the respective floors of the building may be converted to an image format in response to receipt of the image including the representation of the floor plan of a floor of the building.

Although each predefined indoor map of a respective floor of the building may be converted to an image format having a predefined resolution, the predefined indoor maps of respective floors of the building may each be converted, such as by the processing circuitry 22, to a plurality of predefined indoor maps, each in the image format but with a different resolution. For example, a predefined indoor map of the 5th floor of a building may be converted into four different indoor maps having the same image format, but at four different resolutions. In this example embodiment, the apparatus 20, such as the processing circuitry 22, is configured to compare the representation of the floor plan from the image to the predefined indoor maps of respective floors of the building in the image format at each of a plurality of different resolutions.

As shown in block 44 of FIG. 3, the apparatus 20 of an example embodiment also includes means, such as the processing circuitry 22 or the like, for identifying the floor depicted by the floor plan from the image captured by the mobile device based upon the comparison of the representation of floor plan from the image to one or more predefined indoor maps of respective floors. In this regard, the apparatus, such as the processing circuitry, is configured to identify the predefined indoor map of the respective floor of the building that best matches the representation of floor plan from the image with the floor associated with the predefined indoor map that best matches being identified as the floor depicted by the floor plan from the image. In some example embodiments, a predefined threshold is established with the apparatus, such as the processing circuitry, being configured to require the representation of the floor plan from the image to match a predefined indoor map of a respective floor in such a manner as to satisfy the predefined threshold in order for the representation of the floor plan from the image to be considered to match the predefined indoor map. In this example embodiment, in an instance in which the apparatus, such as the processing circuitry, determines that none of the predefined indoor maps of respective floors match the floor plan from the image in such a manner as to satisfy the predefined threshold, the floor associated with representation of the floor plan from the image captured by the mobile device is not identified, but is, instead, identified to be indeterminate and input from the user of the mobile device may be solicited, such as by prompting the user via the user interface 28, to identify the floor on which the image was captured.

In an instance in which the floor depicted by the floor plan from the image captured by the mobile device is identified based upon the comparison of the representation of the floor plan from the image to one or more predefined indoor maps of respective floors in the building, the apparatus 20, such as the processing circuitry 22, may be configured to take further action as shown in block 46. In one embodiment in which the image including the representation of the floor plan of a floor of the building is provided in conjunction with a navigation or a mapping application, the apparatus 20 includes means, such as the processing circuitry 22, the communication interface 26 or the like, for causing positioning information to be provided to the mobile device that identifies the floor of the building on which the mobile device is located. In this instance, the apparatus, such as the processing circuitry, communication interface or the like, may not only provide positioning information that identifies the floor of the building, but may also provide navigational instructions or mapping information that is based upon the floor of the building on which the mobile device has been identified to be located based upon the comparison to predefined indoor maps. In this regard, the navigational instructions or mapping information may utilize the predefined indoor map of the respective floor of the building on which the mobile device has been identified to be located. As a result, the positioning information that is provided to the mobile device may have increased accuracy as a result of being relevant to the floor on which the mobile device is located and, as a result, the user's confidence in the positioning information may be correspondingly increased.

Alternatively, the apparatus 20 of an example embodiment includes means, such as the processing circuitry 22 or the like, for associating the floor that was identified as a result of the comparison with fingerprint data representative of radio signals captured by the mobile device while located on the floor. In this regard, the fingerprint data that is collected includes information regarding the received signal strength (RSS) that is measured by the mobile device and/or other parameters relating to the strength, timing, etc. of the radio signals measured by the mobile device. The received signal strength is a measure of the power present in a received radio signal. The received signal strength may be defined in various manners including as a received signal strength indicator, a received channel power indicator or the like. The fingerprint data also includes an indication of the location of the mobile device at the time at which the signals were received from which the received signal strength and/or other parameters were measured. The location may include a horizontal location, e.g., latitude and longitude, of the mobile device that may be provided in various manners including being based upon information provided by the location sensor 32. In a multi-story building, the location may also include a vertical location, such as the floor of the building on which the mobile device is located which is determined as described above with respect to FIG. 3. Further, the fingerprint data may include a timestamp indicating that time at which the signals were received.

By accurately identifying the floor on which a mobile device is located and associating the floor with the fingerprint data captured by the mobile device, radio maps may be created or updated, such as by the apparatus 20, e.g., the processing circuitry 22, in a manner that results in more accurate radio maps since the fingerprint data will have an increased likelihood of being associated with the correct floor of a multi-story building. Thus, navigational or mapping information subsequently provided based upon the radio maps that have been created or updated will also be more accurate and allow for increased user confidence therein.

The comparison of the representation of the floor plan from an image to one or more predefined indoor maps of respective floors of a multi-story building may be performed in relation to every image that includes a representation of a floor plan of a floor of the multi-story building. For example, the apparatus 20, such as the processing circuitry 22, may be configured to analyze each image captured by a mobile device and to identify every image that includes a representation of a floor plan of a floor of a multi-story building with each resulting image including a representation of a floor plan of a floor of a multi-story building being subjected to comparison to one or more predefined indoor maps of respective floors of the multi-story building. However, in other example embodiments, the apparatus, such as the processing circuitry, may be configured to trigger the comparison process to be performed only in an instance in which the floor of the multi-story building on which the mobile device is located is unknown, thereby conserving processing resources and power by avoiding unnecessary comparisons in an instance in which the floor of a multi-story building on which the mobile device is located is already known.

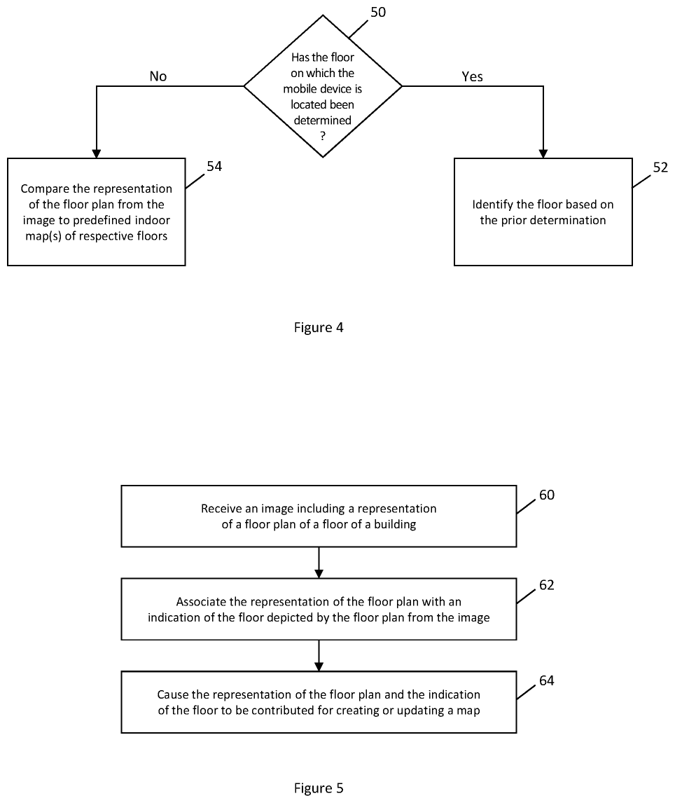

As shown in block 50 of FIG. 4, the apparatus 20 of an example embodiment includes means, such as the processing circuitry 22 or the like, for determining whether the floor depicted by the floor plan from the image captured by the mobile device has already been determined or has not yet been determined. The floor depicted by the floor plan from the image that was captured by the mobile device may have already been determined in various manners. For example, the floor depicted by the floor plan from the image that was captured by the mobile device may have been previously determined as described above in conjunction with the operations of FIG. 3 with no subsequent indication, such as by the barometric sensor 34 as described below, that the mobile device has relocated to a different floor. Alternatively, the floor depicted by the floor plan from the image captured by the mobile device may have been previously determined based upon user input provided to the mobile device, such as via the user interface 28.

In an instance in which the floor depicted by the floor plan from the image captured by the mobile device has already been determined, the apparatus 20 of this example embodiment includes means, such as the processing circuitry 22 or the like, for identifying the floor depicted by the floor plan from the image captured by the mobile device based upon the prior determination of the floor. See block 52. In this regard, the apparatus, such as the processing circuitry, is configured to rely upon the prior determination of the floor without unnecessarily again determining the floor depicted by the floor plan from the image captured by the mobile device in accordance with the operations depicted in the embodiment of FIG. 3. As a result and as shown in block 54 of FIG. 4, the comparison of the representation of the floor plan from an image captured by the mobile device to one or more predefined indoor maps of respective floors of a multi-story building is dependent upon the apparatus, such as the processing circuitry, determining that the floor on which the image was captured has not yet been determined.

The apparatus 20 of an example embodiment may rely upon the user of a mobile device to determine that an image should be captured that includes a representation of a floor plan of the floor of a multi-story building in an instance in which the user is proceeding to or has arrived at a different floor within the building. However, the apparatus of an example embodiment may be configured to trigger the capture of a representation of a floor plan of a floor of a multi-story building in certain circumstances in order to increase the likelihood that an image including a representation of a floor plan of a floor of a multi-story building is available and can be utilized in accordance with the process described above in conjunction with FIG. 3.

In an example embodiment, the apparatus 20, such as the processing circuitry 22, is configured to determine that the floor of which the mobile device is located has changed and to utilize this determination that the floor has changed to trigger the image capture. The apparatus, such as the processing circuitry, may be configured to determine that the floor of which the device is located has changed in various manners. In one example embodiment, the apparatus may include a barometric sensor 34 or may be associated or in communication with a barometric sensor. As such, the apparatus, such as the processing circuitry, of this example embodiment may be configured to determine that the floor on which the mobile device is located has changed in instance in which the signals provided by the barometric sensor change by at least a predefined amount. In this regard, the predefined amount by which the signals provided by the barometric sensor must change may be an amount that is indicative of a change in altitude that equals or exceeds the height of the floors of the multi-story building. While it may be difficult to reliably determine the floor on which the mobile device is located based upon the signals provided by a barometric sensor, the signals provided by a barometric sensor will allow for accurate relative measurements and, as a result, allow for the determination of a change in floor on which the mobile device is located. The apparatus, such as the processing circuitry, may be configured to determine that the floor on which the mobile device is located has changed in other manners, such as based upon input by the user of the mobile device, such as via the user interface 28.

In response to the determination that the floor on which the mobile device is located has changed, the apparatus 20 of this example embodiment, such as the processing circuitry 22, is configured to trigger the image to be captured by the mobile device or to cause a user of the mobile device to be prompted, such as via the user interface 28, to capture the image. In an instance in which the mobile device is triggered to capture the image, the mobile device, and more particularly, an image capture device 30, e.g., a camera, of the mobile device may be configured to capture one or more images, which are subsequently analyzed by the processing circuitry until such time that the processing circuitry identifies that an image captured by the image capture device includes a representation of a floor plan of a floor of the multi-story building. Alternatively, in an instance in which a user of the mobile device is prompted to capture the image, the user of the mobile device may be prompted via the user interface to capture an image that includes a representation of the floor plan of the floor of the multi-story building on which the mobile device is currently located. Although the mobile device may be triggered to capture an image based upon a determination that the floor on which the mobile device is located has changed, the apparatus, such as the processing circuitry, may be configured to trigger the image to be captured by the mobile device or to cause a user of the mobile device to be prompted to capture an image in other circumstances, such as following the passage of a predefined period of time since the prior capture of an image or a determination that the mobile device has been repositioned by at least a predefined distance since the prior capture of an image.

Although the apparatus 20, such as the processing circuitry 22, of an example embodiment may be configured to compare each image captured by the mobile device to one or more predefined indoor maps of the respective floors of a multi-story building in an effort to identify an instance in which a representation of a floor plan of a floor of a multi-story building is included in the image that has been captured and, if so identified, to also identify the predefined indoor map of a respective floor that best matches the representation of the floor plan from the image, the apparatus, such as the processing circuitry, of an example embodiment may alternatively be configured to perform the comparison only in certain circumstances, thereby again conserving processing resources and power. In this example embodiment, the apparatus, such as the processing circuitry, may be configured to determine that a predefined application, such as a mapping or navigation application, has been launched. In response to determining that the predefined application has been launched, the apparatus, such as the processing circuitry, may be configured to begin performing an image analysis upon the images that are captured by the mobile device to identify whether the image includes a representation of a floor plan of a floor of a multi-story building. Alternatively, the apparatus, such as the processing circuitry, may be responsive to input provided by the user of the mobile device that indicates that an image is captured including a representation of a floor plan of a floor of a multi-story building.

In an instance in which the apparatus 20, such as the processing circuitry 22, does not determine that the mobile device is capturing an image that includes a representation of a floor plan of a floor of a multi-story building, the apparatus, such as the processing circuitry, of this example embodiment need not compare the image to one or more predefined indoor maps of respective floors of a multi-story building. Instead, the apparatus, such as processing circuitry, of this example embodiment only performs the comparison of the representation of the floor plan from the image to one or more predefined indoor maps of respective floors in an instance in which the apparatus, such as the processing circuitry, has previously determined that the image has been captured that includes a representation of the floor plan of a floor of a multi-story building. Thus, the comparison of the representation of floor plan from the image to one or more predefined indoor maps of respective floors is dependent upon determining that the mobile device is capturing an image including a representation of the floor plan.

The apparatus 20, such as the processing circuitry 22, may be configured to compare a representation of a floor plan of a floor of a multi-story building to predefined indoor maps of all of the floors of the multi-story building or to predefined indoor maps of all of the floors of one or more buildings located proximate to the horizontal, e.g. latitude and longitude, location of the mobile device, such as determined by the location sensor 32. However, in some embodiments, the apparatus, such as the processing circuitry, is configured to identify the most likely floors on which the mobile device is located and to only perform (or at least initially perform) the comparison of the representation of the floor plan from the image to the predefined indoor maps of those floors upon which the mobile device is most likely located, thereby further conserving processing resources and power.

In this example embodiment, the apparatus 20, such as the processing circuitry 22, is configured to determine an approximate location of the mobile device. This approximate location may include both the horizontal location of the mobile device, such as latitude and longitude of the mobile device, as well as the altitude of the mobile device. Based upon the altitude of the mobile device, the apparatus, such as the processing circuitry, may be configured to determine the approximate floor on which the mobile device is located, such as based upon the altitude of the mobile device and the height of each floor within the multi-story building or an average height of floors within buildings of the same type. The approximate location of the mobile device maybe determined in other manners including, for example, based upon input provided by user of the mobile device. Regardless of the manner in which the approximate location is determined, the apparatus, such as the processing circuitry, of this example embodiment is configured to compare the representation of the floor plan from the image to one or more predefined indoor maps by selecting one or more predefined indoor maps for comparison to the representation of the floorplan from the image. In this regard, the predefined indoor map from the floor of the building corresponding to the approximate location of the mobile device may be selected for comparison purposes as well as the predefined indoor maps for a predetermined number of floors above and below the floor that corresponds to the approximate location of the mobile device. By including predefined indoor maps for a predetermined number of floors above and below the floor corresponding to the approximate location of the mobile device, the apparatus, such as the processing circuitry, increases the likelihood that the representation of the floor plan from the image will match one of the predefined indoor maps, while still limiting the number of indoor maps that must be compared to the representation of the floor plan from the image.

In an example embodiment, the apparatus 20, such as the processing circuitry 22, is also configured to select the one or more predefined indoor maps for comparison purposes only for the building in which the approximate location of mobile device is associated and not for one or more buildings surrounding or nearby the building in which the approximate location is located, thereby further limiting the number of predefined indoor maps to be compared to the representation of floor plan from the image.

While the method, apparatus 20 and computer program product of an example embodiment may be configured to identify the floor on which an image including a representation of a floor plan of a floor of a multi-story building was captured by a mobile device, such as in conjunction with the provision of positioning information to the mobile device by a navigation or mapping application and/or in conjunction with the creation of fingerprint data utilized to create or update a radio map, the method, apparatus, computer program product of another example embodiment may be utilized for purposes of creating or updating a map. As shown in block 60 of FIG. 5, the apparatus of this example embodiment includes means, such as a processing circuitry 22, the communication interface 26 or the like, for receiving an image captured by a mobile device. The image includes a representation of a floor plan of a floor of a multi-story building and may be received as described above in conjunction with block 40 of FIG. 3. The apparatus of this example embodiment also includes means, such as the processing circuitry or the like, for associating the representation of the floor plan from the image with an indication of the floor depicted by the image captured by the mobile device. See block 62.

The indication of the floor depicted by the image captured by the mobile device may be provided in various manners. For example, the apparatus 20 may include means, such as the processing circuitry 22, the communication interface 26 or the like, for receiving the indication of the floor depicted by the image captured by the mobile device based upon the image captured by the mobile device that includes the indication of the floor. In this regard, the image that includes the representation of the floor plan of a respective floor may also include an indication of the floor with which the floor plan is associated, such as the numeral 1 in instance in which the floor plan from the image is associated with the first floor of the multi-story building. Alternatively, the apparatus may include means, such as the processing circuitry, the communication interface or the like, for receiving the indication the floor depicted by the image captured by the mobile device based upon input provided by the user of the mobile device, such as via the user interface 28, that identifies the floor depicted by the image captured by the mobile device.

Regardless of the manner in which the indication of the floor depicted by the image captured by the mobile device was provided, the apparatus 20 of this example embodiment includes means, such as the processing circuitry 22, the communication interface 26 or the like, for causing the representation the floor plan and the indication of the floor to be contributed for purposes of creating or updating a map. See block 64 of FIG. 5. In this regard, the representation of the floor plan and the indication of the floor may be provided to a map database with the representation of the floor plan from the image then being utilized to create a predefined indoor map of the respective floor identified by the indication. In this manner, the method, apparatus and computer program product may provide for the creation or updating of a map including predefined floor plans of the floors of a multi-story building in a timely and efficient manner utilizing the representations of the floor plans from the images captured by the mobile device.

As described above, FIGS. 3-5 are flowcharts of an apparatus 20, method, and computer program product configured to identify a floor of a multi-story building according to an example embodiment. It will be understood that each block of the flowcharts, and combinations of blocks in the flowcharts, may be implemented by various means, such as hardware, firmware, processing circuitry 22, and/or other devices associated with execution of software including one or more computer program instructions. For example, one or more of the procedures described above may be embodied by computer program instructions. In this regard, the computer program instructions which embody the procedures described above may be stored by the memory 24 of the apparatus and executed by the processing circuitry or the like. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for identifying a floor of a building, the method comprising:
receiving an image captured by a mobile device, the image including a representation of a floor plan of the floor of the building;
comparing, with processing circuitry, the representation of the floor plan from the image to one or more predefined indoor maps of respective floors; and
based upon the comparing, identifying, with the processing circuitry, the floor depicted by the floor plan from the image captured by the mobile device.

2. A method according to claim 1, further comprising causing positioning information to be provided to the mobile device that identifies the floor of the building on which the mobile device is located.

3. A method according to claim 1, further comprising associating the floor that was identified with fingerprint data representative of radio signals captured by the mobile device while located on the floor.

4. A method according to claim 1, further comprising:
determining whether the floor on which the mobile device is located has already been determined or has not yet been determined,
wherein comparing the representation of the floor plan from the image captured by the mobile device to one or more predefined indoor maps of respective floors is dependent upon determining that the floor on which the mobile device is located has not yet been determined.

5. A method according to claim 1, further comprising:
determining that the floor on which the mobile device is located has changed; and
in response to the floor on which the mobile device is located changing, triggering the image to be captured by the mobile device or causing a user of the mobile device to be prompted to capture the image.

6. A method according to claim 1, further comprising determining that the mobile device is capturing the image, wherein comparing the representation of the floor plan to one or more predefined indoor maps of respective floors is dependent upon determining that the mobile device is capturing the image.

7. A method according to claim 1, further comprising determining an approximate location of the mobile device, wherein comparing the representation of the floor plan from the image to one or more predefined indoor maps comprises selecting the one or more predefined indoor maps for comparison to the representation of the floor plan from the image based upon the approximate location of the mobile device.

8. A method according to claim 1, wherein comparing the representation of the floor plan from the image to one or more predefined indoor maps comprises comparing the representation of the floor plan from the image to a plurality of indoor maps of different resolutions of each of one or more floors of the building.

9. An apparatus configured to identify a floor of a building, the apparatus comprising processing circuitry and at least one memory including computer program code instructions, the computer program code instructions configured to, when executed by the processing circuity, cause the apparatus to:
receive an image captured by a mobile device, the image including a representation of a floor plan of the floor of the building;
compare the representation of the floor plan from the image to one or more predefined indoor maps of respective floors; and
based upon the comparison, identify the floor depicted by the floor plan from the image that was captured by the mobile device.

10. An apparatus according to claim 9, wherein the computer program code instructions are further configured to, when executed by the processing circuity, cause the apparatus to cause positioning information to be provided to the mobile device that identifies the floor of the building on which the mobile device is located.

11. An apparatus according to claim 9, wherein the computer program code instructions are further configured to, when executed by the processing circuity, cause the apparatus to associate the floor that was identified with fingerprint data representative of radio signals captured by the mobile device while located on the floor.

12. An apparatus according to claim 9, wherein the computer program code instructions are further configured to, when executed by the processing circuity, cause the apparatus to:
determine whether the floor on which the mobile device is located has already been determined or has not yet been determined,
wherein the computer program code instructions are configured to, when executed by the processing circuity, cause the apparatus to compare the representation of the floor plan to one or more predefined indoor maps of respective floors only in an instance in which the floor on which the mobile device is located has not yet been determined.

13. An apparatus according to claim 9, wherein the computer program code instructions are further configured to, when executed by the processing circuity, cause the apparatus to:
determine that the floor on which the mobile device is located has changed; and
in response to the floor on which the mobile device is located changing, trigger the image to be captured by the mobile device or causing a user of the mobile device to be prompted to capture the image.

14. An apparatus according to claim 9, wherein the computer program code instructions are further configured to, when executed by the processing circuity, cause the apparatus to determine that the mobile device is capturing the image, and wherein the computer program code instructions are configured to, when executed by the processing circuity, cause the apparatus to compare the representation of the floor plan to one or more predefined indoor maps of respective floors in a manner that is dependent upon determining that the mobile device is capturing the image.

15. An apparatus according to claim 9, wherein the computer program code instructions are further configured to, when executed by the processing circuity, cause the apparatus to determine an approximate location of the mobile device, and wherein the computer program code instructions are configured to, when executed by the processing circuity, cause the apparatus to compare the representation of the floor plan from the image to one or more predefined indoor maps by selecting the one or more predefined indoor maps for comparison to the representation of the floor plan from the image based upon the approximate location of the mobile device.

16. An apparatus according to claim 9, wherein the computer program code instructions are further configured to, when executed by the processing circuity, cause the apparatus to compare the representation of the floor plan from the image to one or more predefined indoor maps by comparing the representation of the floor plan from the image to a plurality of indoor maps of different resolutions of each of one or more floors of the building.

17. A method comprising:
receiving an image captured by a mobile device, the image including a representation of a floor plan of a floor of a building;
associating, with processing circuitry, the representation of the floor plan with an indication of the floor depicted by the floor plan from the image captured by the mobile device; and
causing the representation of the floor plan and the indication of the floor to be contributed for purposes of creating or updating a map.

18. A method according to claim 17, further comprising receiving the indication of the floor depicted by the floor plan from the image captured by the mobile device based upon an image captured by the mobile device that includes the indication of the floor.

19. A method according to claim 17, further comprising receiving the indication of the floor depicted by the floor plan from the image captured by the mobile device based upon input by a user of the mobile device of the floor on which the mobile device is located.

20. A method according to claim 17, further comprising creating or updating the map of the floor based upon the representation of the floor plan.
